(19) United States
(12) Patent Application Publication
(10) Pub. No.: US 2016/0294986 A1
(43) Pub. Date: Oct. 6, 2016

(54) Data Transmission Method And Device

(71) Applicant: BEIJING BAIDU NETCOM SCIENCE AND TECHNOLOGY CO., LTD., Beijing (CN)

(72) Inventors: Jian ZHANG, Beijing (CN); Chao PEI, Beijing (CN); Xiaoguang LIU, Beijing (CN); Hao JIANG, Beijing (CN); Tao LIU, Beijing (CN); Ning LIU, Beijing (CN); Cheng ZHANG, Beijing (CN)

(21) Appl. No.: 14/983,929

(22) Filed: Dec. 30, 2015

(30) Foreign Application Priority Data
Apr. 1, 2015 (CN) 201510152177.8

(51) Int. Cl. H04L 29/06; H04L 29/08

(52) U.S. Cl. CPC H04L 69/08; H04L 69/165; H04L 69/329

(57) ABSTRACT

The present disclosure provides a data transmission method and a data transmission device. The data transmission method includes: receiving data sent by an application layer via a Transmission Control Protocol (TCP) interface; performing a protocol conversion when an acceleration mode is started, wherein the protocol conversion refers to converting TCP to a preset User Datagram Protocol (UDP); and sending the data in a transmission layer by using the preset UDP. The data transmission method may improve a transmission speed under a mobile network scene, and reduce a time delay of data transmission, thus enhancing a user experience.

### CROSS-REFERENCE TO RELATED APPLICATION

This application is based on and claims priority to Chinese Patent Application Serial No. 201510152177.8, filed with the State Intellectual Property Office of P. R. China on Apr. 1, 2015, the entire contents of which are incorporated herein by reference.

### FIELD

The present disclosure relates to mobile communication technology filed, and more particularly to a data transmission method and a data transmission device.

### BACKGROUND

Currently, most of application layers in the internet realize a reliable data transmission by using the Transmission Control Protocol (TCP). In a traditional fixed network scenario with relatively excellent network quality and lower end-to-end delay, there is no obvious deficiency in the aspect of users' experience. However, in a mobile network scenario, which has a relatively higher network delay and narrower network bandwidth as compared with the fixed network scenario, the data transmission is slower and the transmission delay is greater if the application layer transmits data by using the TCP, thus affecting users' experience.

### SUMMARY

The present disclosure aims to solve at least one of above technical problems in the related art.

Therefore, one objective of the present disclosure is to provide a data transmission method, which may improve a data transmission speed and reduce a data transmission delay in a mobile network scene, thus enhancing a user experience.

Another objective of the present disclosure is to provide a data transmission device.

To achieve the above objectives, embodiments of a first aspect of the present disclosure provide a data transmission method. The method comprises: receiving data sent by an application layer via a TCP interface; performing a protocol conversion when an acceleration mode is started, in which the protocol conversion refers to converting TCP to a preset User Datagram Protocol (UDP); and sending the data in a transmission layer by using the preset UDP.

With the data transmission method provided in embodiments of the first aspect of the present disclosure, by converting TCP to a preset UDP and sending data in a transmission layer by using the preset UDP, the data transmission speed in the mobile network scene may be improved and the data transmission delay in the mobile network scene may be reduced, as compared with transmitting data in the transmission layer by using the TCP, thus enhancing a user experience.

To achieve the above objectives, another data transmission method is provided in embodiments of a second aspect of the present disclosure, and the data transmission method includes: receiving data sent by a sending end, in which the data is sent in a transmission layer by using a preset UDP; performing a protocol conversion when an acceleration mode is started, in which the protocol conversion refers to converting the preset UDP to TCP; and sending the data to an application layer via a TCP interface by using TCP.

With the data transmission method provided in embodiments of the second aspect of the present disclosure, by transmitting the data in the transmission layer using the preset UDP, the data transmission speed in the mobile network scene may be improved and the data transmission delay in the mobile network scene may be reduced, as compared with transmitting data in the transmission layer by using the TCP, thus enhancing a user experience. In addition, the application layer may still transmit data using the TCP interface, thus reducing an effect on the application layer.

To achieve the above objectives, a data transmission device is provided in embodiments of a third aspect of the present disclosure, in which the data transmission device includes a processor and a memory configured to store instructions executable by the processor, and the processor is configured to: receive data sent by an application layer via a TCP interface; perform a protocol conversion when an acceleration mode is started, in which the protocol conversion refers to converting TCP to a preset UDP; and send the data in a transmission layer by using the preset UDP.

With the data transmission device provided in embodiments of the third aspect of the present disclosure, by converting TCP to a preset UDP and sending the data in a transmission layer using the preset UDP, the data transmission speed in the mobile network scene may be improved and the data transmission delay in the mobile network scene may be reduced, as compared with transmitting data in the transmission layer by using the TCP, thus enhancing a user experience.

To achieve the above objectives, another data transmission device is provided in embodiments of a fourth aspect of the present disclosure, in which the data transmission device includes a processor and a memory configured to store instructions executable by the processor, and the processor is configured to: receive data sent by a sending end, in which the data is sent in a transmission layer by using a preset UDP; perform a protocol conversion when an acceleration mode is started, in which the protocol conversion refers to converting the preset UDP to TCP; and send the data to an application layer via a TCP interface by using the TCP.

With the data transmission device provided in embodiments of the fourth aspect of the present disclosure, by transmitting the data in the transmission layer using the preset UDP, the data transmission speed in the mobile network scene may be improved and the data transmission delay in the mobile network scene may be reduced, as compared with transmitting data in the transmission layer by using the TCP, thus enhancing a user experience. In addition, the application layer may still transmit data using the TCP interface, thus reducing an effect on the application layer.

The various aspects and advantages of the present disclosure are presented herein. It is to be understood that certain aspects and advantages of the present disclosure may become obvious in light of the descriptions presented herein. Some other aspects and advantages of the present disclosure may be learned or realized in practice by following the teaching of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a flow chart of a data transmission method according to an embodiment of the present disclosure;

FIG. 2 is a flow chart of a data transmission method according to another embodiment of the present disclosure;

FIG. 3 is a schematic diagram showing a data transmission system according to an embodiment of the present disclosure;

FIG. 4 is a block diagram of a data transmission device according to another embodiment of the present disclosure;

FIG. 5 is a block diagram of a data transmission device according to another to embodiment of the present disclosure;

FIG. 6 is a block diagram of a data transmission device according to another embodiment of the present disclosure;

FIG. 7 is a block diagram of a data transmission device according to another embodiment of the present disclosure.

### DETAILED DESCRIPTION

In the following, the present disclosure will be described in detail with reference to drawings and embodiments. It should be understood that, the specific embodiments described herein are only used to illustrate the present disclosure but do not limit the scope of the present disclosure. Based on embodiments of the present disclosure, other embodiments obtained by those having ordinary skills in the related art without making creative labors fall into a protection scope of the present disclosure.

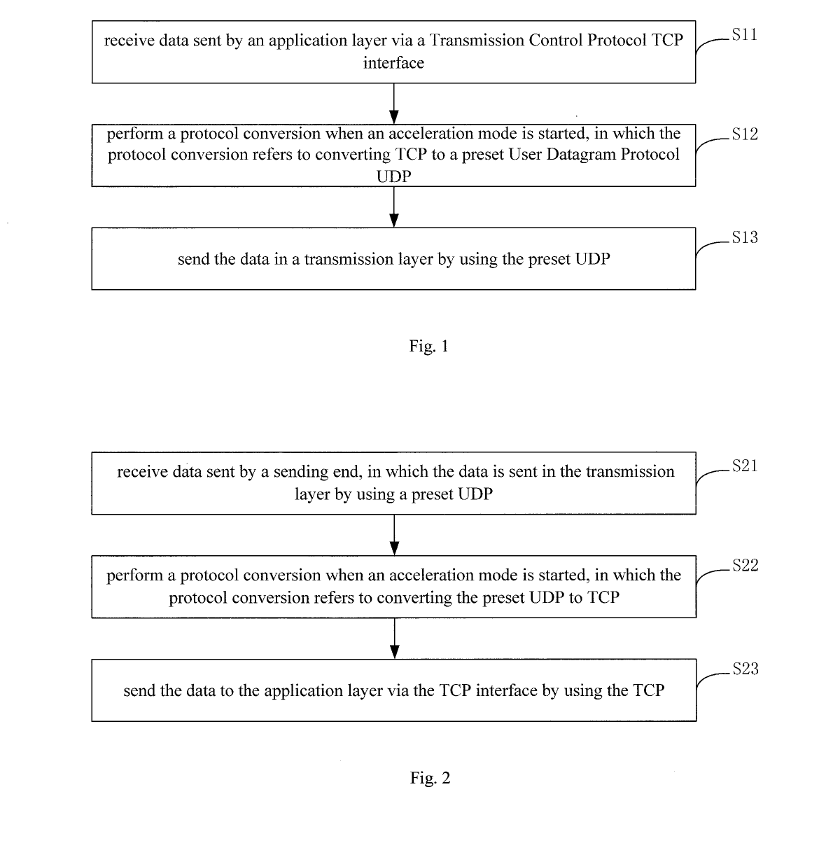

FIG. 1 is a flow chart of a data transmission method according to an embodiment of the present disclosure. As shown in FIG. 1, the data transmission method is performed at a sending end, and the data transmission method includes the following steps.

In step S11, data sent by an application layer via a Transmission Control Protocol (TCP) interface is received.

In the present embodiment, the application layer may still use the TCP interface when transmitting data. In addition, the application layer does not need to use specific protocols such as the SPDY protocol, but may still use a common HyperText Transfer Protocol HTTP.

In step S12, a protocol conversion is performed when an acceleration mode is started, in which the protocol conversion refers to converting TCP to a preset User Datagram Protocol (UDP).

It may be determined whether the acceleration mode is to be started according to whether a UDP connection is available, for example, if the UDP connection is available, the acceleration mode is started, and if the UDP connection is not available, the TCP is still used in the transmission layer.

The preset UDP may be a UDP based reliable transmission protocol.

In an embodiment, an improvement may be performed to a common UDP, such that the improved UDP may satisfy a reliable transmission requirement.

For example, in the transmission layer, data to be sent is divided into multiple data messages, which are numbered, and a feedback mechanism is adopted. For example, when a client sends data to a server, the client waits for a confirmation signal sent by the server each time after sending a data message, and then sends a next data message after receiving the confirmation signal. If the client does not receive the confirmation signal within the predetermined waiting time, the client sends the data message again, thus ensuring no packet loss. Furthermore, the server may store the data messages received in order according to numbers of the data messages, so as to realize a data transmission in sequence. Obviously, it can be understood that, other rules may be set for realizing other reliable mechanisms, which will not be listed herein.

In an embodiment, the protocol conversion may be performed as follows.

At the client end, a preset Application Programming Interface (API) is called, and the protocol conversion is performed by using the preset API.

Alternatively, the protocol conversion may be performed at the server end by using a protocol endpoint.

In an embodiment, if the client end needs to send data to the server end, the application layer of the client end may call the preset API, and convert TCP to the preset UDP by calling the API.

If the server end needs to send data to the client end, the server end may introduce the protocol endpoint, so as to convert TCP to the preset UDP.

In one embodiment, in the protocol conversion, for example, after receiving data from the application layer, an encapsulation is performed according to the encapsulation requirement of the preset UDP, thus obtaining encapsulated data in the transmission layer.

In step S13, the data is sent in the transmission layer by using the preset UDP.

The application layer may still send data via the TCP interface, as the protocol conversion has been performed, and the data sent by the application layer via the TCP interface is encapsulated and transmitted in the transmission layer according to the preset UDP.

In a traditional TCP data transmission, a congestion control strategy is started if a packet loss is detected.

However, in one embodiment of the present disclosure, when sending data by using the preset UDP, a transmission strategy of sending data smoothly is used, without starting the congestion control strategy.

In one embodiment, the data is sent as follows.

First, a current network transmission condition is obtained. Then, a transmission time required by each data message is computed according to the current network transmission condition, and a sending time of each data message is determined according to the transmission time, such that each data message may be sent at a corresponding sending time.

In one embodiment, the network transmission condition may be 2G 3G or WiFi, and different network transmission conditions have different transmission speed, for example, the transmission speed in WiFi environment is generally faster than that in 3G and the transmission speed in 3G is generally faster than that in 2G Thus, the data message may be sent at different time in different network transmission conditions. In addition, in one embodiment of the present disclosure, the sending time of each data message is computed according to the transmission time required by each data message, such that the data message congestion usually does not occur and the congestion control mechanism is not started, thus accelerating the data transmission speed.

In addition, in another embodiment, the traditional TCP data transmission is connection-oriented, and the client end and the server end need to perform three hand-shakings so as to establish a connection therebetween for data transmission, thus causing a data transmission delay.

In another embodiment, since the preset UDP, which is dedicated to a UDP protocol, is used to transmit data, it does not need to perform three hand-shakings for establishing a connection between the server and the client before transmitting data. Instead, it is possible to carry data in the first data message sent. For example, when the client sends data to the server, the client sends the first data message to the server, in which the first data message carries data.

Alternatively, after receiving the first data message, the server sends a secret key to the client. After receiving the secret key, the client sends subsequent data messages to the server, in which the subsequent data message carry data encrypted using the secret key.

In another embodiment, by encrypting the data with the secret key, the safety of data transmission may be improved.

In another embodiment, by converting TCP to a preset UDP and sending the data in a transmission layer using the preset UDP, the data transmission speed in the mobile network scene may be improved and the data transmission delay in the mobile network scene may be reduced, as compared with transmitting data in the transmission layer by using the TCP, thus enhancing a user experience. In addition, the application layer may still transmit data using the TCP interface, thus reducing an effect on the application layer.

FIG. 2 is a flow chart of a data transmission method according to another embodiment of the present disclosure. As shown in FIG. 2, the data transmission method is performed at a receiving end, and the data transmission method includes the following steps.

In step S21, data sent by a sending end is received, in which the data is sent in the transmission layer by using a preset UDP.

The preset UDP may be a UDP based reliable transmission protocol. The specific content may refer to the above embodiment, which will not be elaborated here.

In step S22, a protocol conversion is performed when an acceleration mode is started, in which the protocol conversion refers to converting the preset UDP to TCP.

The application layer may still use a TCP interface when receiving data. In order to reduce an effect on the application layer, the preset UDP may be converted to TCP in the present embodiment, since the preset UDP is used in the transmission layer.

If the data is sent from the client to the server, the transmission layer of the receiving end may first send the data to a protocol endpoint.

Alternatively, if the data is sent from the server to the client, a preset API interface of the transmission layer receives the data using the preset UDP, and a protocol conversion is performed so as to convert the data using the preset UDP to data using TCP.

In one embodiment, in the protocol conversion, payload data is obtained from the data using the preset UDP according to the encapsulation requirement of the preset UDP, and then the payload data is encapsulated according to the encapsulation requirement of TCP so as to obtain the data using TCP.

In step S23, the data is sent to the application layer via the TCP interface by using the TCP.

With the protocol conversion, the data using the preset UDP is converted to the data using TCP, and then the data using TCP may be transmitted to the application layer via the TCP interface.

Corresponding to the client, the first data message received by the server may carry data. In addition, the data encryption transmission may be used. In certain embodiments, the method may further include following operations.

The server sends a secret key to the client after receiving the first data message, and the server receives subsequent data messages sent by the client after sending the first data message, in which the subsequent data messages carry data encrypted using the secret key.

In another embodiment, by transmitting the data in the transmission layer using the preset UDP, the data transmission speed in the mobile network scene may be improved and the data transmission delay in the mobile network scene may be reduced, as compared with transmitting data in the transmission layer by using the TCP, thus enhancing a user experience. In addition, the application layer may still transmit data using the TCP interface, thus reducing an effect on the application layer.

Described above are from a single side, an example of transmitting data between the client and the server is described as follows.

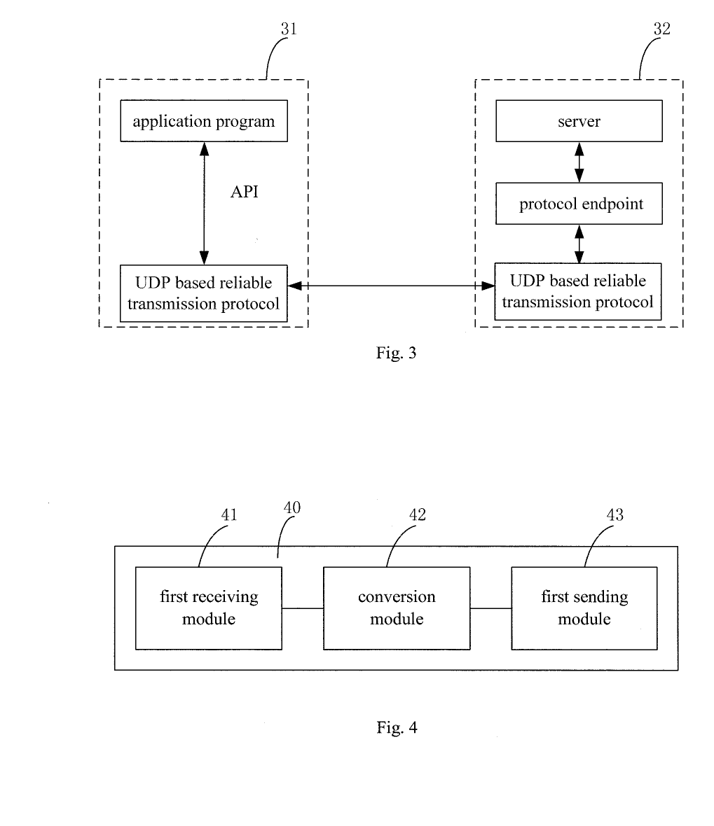

As shown in FIG. 3, a data transmission system includes a client end 31 and a server end 32. The client end may include an application program in an application layer and a transmission layer using the UDP based reliable transmission protocol. The server end may include a server, a protocol endpoint and a transmission layer using the UDP based reliable transmission protocol, in which, the server may still use the TCP interface to transmit data in the application layer, and the protocol endpoint is used to perform an inter-conversion between TCP and the UDP based reliable transmission protocol.

As shown in FIG. 3, taking sending data from the client end to the server end as an example, the application layer of the client end may use the TCP interface to transmit data, and may realize the conversion from TCP to the UDP based reliable transmission protocol by calling a preset API when sending data. In the transmission layer, the client end and the server end use the UDP based reliable transmission protocol to transmit data. The protocol endpoint is added in the server end. When the server receives data, the protocol endpoint converts the UDP based reliable transmission protocol to TCP, and the server may keep unchanged. On the other hand, when the server sends data to the client, the protocol endpoint converts TCP to the UDP based reliable transmission protocol. At the client end, the UDP based reliable transmission protocol used by the data in the transmission layer is converted to TCP by using the preset API.

In another embodiment, the preset API may be simply called at the client end without changing the server, and thus the data transmission method may be used in an application program of a regular client end with low cost and without relying on the operating system environment of the client end. On the premise of performing no adaptation on previous business, the transmission delay may be reduced. Moreover, the development framework of the server end is simple, which is convenient in operating and managing with low upgrading cost.

FIG. 4 is a block diagram of a data transmission device according to another embodiment of the present disclosure, an as shown in FIG. 4, the data transmission device 40 includes a first receiving module 41, a conversion module 42, and a first sending module 43.

The first receiving module 41 is configured to receive data sent by an application layer via a TCP interface.

The application layer of the present embodiment may still use the TCP interface when transmitting data. In another embodiment, the application layer does not need to use specific protocols such as the SPDY protocol, but may still use a common HTTP.

The conversion module 42 is configured to perform a protocol conversion when an acceleration mode is started, in which the protocol conversion refers to converting TCP to a preset User Datagram Protocol (UDP).

It may be determined whether the acceleration mode is to be started according to whether a UDP connection is available, for example, if the UDP connection is available, the acceleration mode is started, and if the UDP connection is not available, the TCP is still used in the transmission layer.

The preset UDP may be a UDP based reliable transmission protocol.

In an embodiment, an improvement may be performed to a common UDP, such that the improved UDP may satisfy a reliable transmission requirement.

For example, in the transmission layer, data to be sent is divided into multiple data messages, which are numbered, and a feedback mechanism is adopted. For example, when a client sends data to a server, the client waits for a confirmation signal sent by the server each time after sending a data message, and then sends a next data message after receiving the confirmation signal. If the client does not receive the confirmation signal within the predetermined waiting time, the client sends the data message again, thus ensuring no packet loss. Furthermore, the server may store the data messages received in order according to numbers of the data messages, so as to realize a data transmission in sequence. Obviously, it can be understood that, other rules may be set for realizing other reliable mechanisms, which will not be listed herein.

In an embodiment, the conversion module 42 is specifically configured to:

call a preset API at a client end, and perform the protocol conversion by using the preset API; or

perform the protocol conversion at a server end by using a protocol endpoint.

In an embodiment, if the client end needs to send data to the server end, the application layer of the client end may call the preset API, and convert TCP to the preset UDP by calling the API.

In another embodiment, if the server end needs to send data to the client end, the server end may introduce the protocol endpoint, so as to convert TCP to the preset UDP.

In one embodiment, in the protocol conversion, for example, after receiving data from the application layer, an encapsulation is performed according to the encapsulation requirement of the preset UDP, thus obtaining encapsulated data in the transmission layer.

The first sending module 43 is configured to send the data in a transmission layer by using the preset UDP.

The application layer may still send data via the TCP interface, as the protocol conversion is performed, and the data sent by the application layer via the TCP interface is encapsulated and transmitted in the transmission layer according to the preset UDP.

In a traditional TCP data transmission, a congestion control strategy is started if a packet loss is detected.

However, in one embodiment of the present disclosure, when sending data by using the preset UDP, a transmission strategy of sending data smoothly is used, without starting the congestion control strategy.

In one embodiment, the first sending module 43 is specifically configured to:

obtain a current network transmission condition;

compute a transmission time required by each data message according to the current network transmission condition;

determine a sending time of each data message according to the transmission time; and

send each data message at a corresponding sending time.

In one embodiment, the network transmission condition may be 2G, 3G or WiFi, and different network transmission conditions have different transmission speed, for example, the transmission speed in WiFi environment is generally faster than that in 3G and the transmission speed in 3G is generally faster than that in 2G. Thus, the data message may be sent at different time in different network transmission conditions. In addition, in one embodiment of the present disclosure, the sending time of each data message is computed according to the transmission time required by each data message, such that the data message congestion usually does not occur and the congestion control mechanism is not started, thus accelerating the data transmission speed.

In addition, the traditional TCP data transmission is connection-oriented, and the client end and the server end need to perform three hand-shakings so as to establish a connection therebetween for data transmission, thus causing a data transmission delay.

In one embodiment, since the preset UDP, which is dedicated to a UDP protocol, is used to transmit data, it does not need to perform three hand-shakings for establishing a connection between the server and the client before transmitting data. Instead, it is possible to carry data in the first data message sent.

In one embodiment, when the client sends data to the server, the first sending module 43 is specifically configured to send the first data message to the server, in which the first data message carries data.

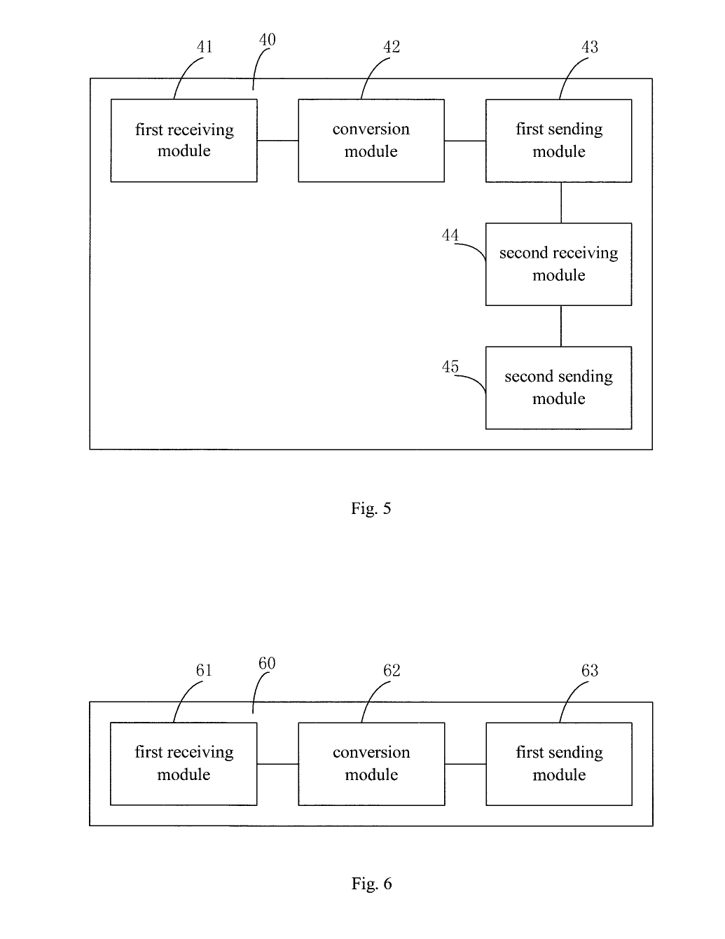

In another embodiment, as shown in FIG. 5, the data transmission device 40 further includes a second receiving module 44 and a second sending module 45.

The second receiving module 44 is configured to receive a secret key sent by the server, in which the secret key is sent by the server after receiving the first data message.

The second sending module 45 is configured to send subsequent data messages to the server, in which the subsequent data messages carry data encrypted using the secret key.

In one embodiment of the present disclosure, by encrypting the data with the secret key, the safety of data transmission may be improved.

In another embodiment of the present disclosure, by converting TCP to a preset UDP and sending the data in a transmission layer using the preset UDP, the data transmission speed in the mobile network scene may be improved and the data transmission delay in the mobile network scene may be reduced, as compared with transmitting data in the transmission layer by using the TCP, thus enhancing a user experience. In another aspect, the application layer may still transmit data using the TCP interface, thus reducing an effect on the application layer.

FIG. 6 is a block diagram of a data transmission device according to another embodiment of the present disclosure, and as shown in FIG. 6, the data transmission device 60 includes a first receiving module 61, a conversion module 62, and a first sending module 63.

The first receiving module 61 is configured to receive data sent by a sending end, in which the data is sent in a transmission layer by using a preset UDP.

The preset UDP may be a UDP based reliable transmission protocol. The specific content may refer to the above embodiment, which will not be elaborated here.

The conversion module 62 is configured to perform a protocol conversion when an acceleration mode is started, in which the protocol conversion refers to converting the preset UDP to TCP.

The application layer may still use a TCP interface when receiving data. In order to reduce an effect on the application layer, the preset UDP may be converted to TCP in the present embodiment, since the preset UDP is used in the transmission layer.

If the data is sent from the client to the server, the transmission layer of the receiving end may first send the data to a protocol endpoint.

Alternatively, if the data is sent from the server to the client, a preset API interface of the transmission layer receives the data using the preset UDP, and a protocol conversion is performed, so as to convert the data using the preset UDP to data using TCP.

In one embodiment, in the protocol conversion, payload data is obtained from the data using the preset UDP according to the encapsulation requirement of the preset UDP, and then the payload data is encapsulated according to the encapsulation requirement of TCP so as to obtain the data using TCP.

The first sending module 63 is configured to send the data to the application layer via the TCP interface by using the TCP.

With the protocol conversion, the data using the preset UDP is converted to the data using TCP, and then the data using TCP may be transmitted to the application layer via the TCP interface.

In an embodiment, if the data is received by the server from the client, the first receiving module 61 is specifically configured to receive a first data message sent from the client, in which the first data message carries data.

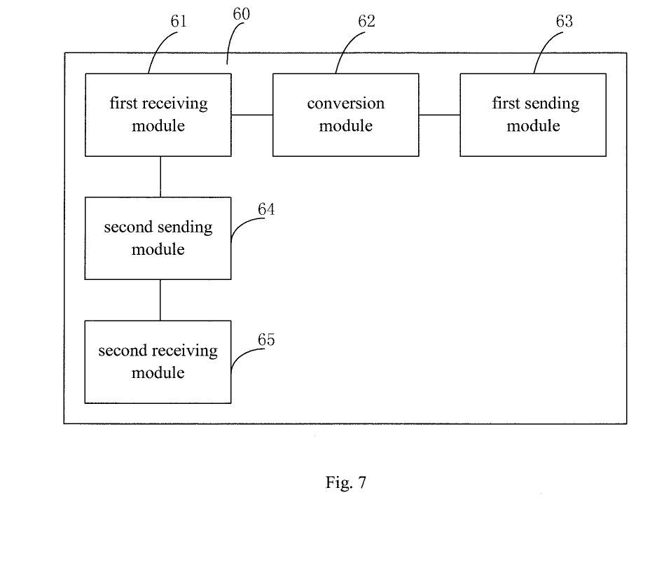

In another embodiment, as shown in FIG. 7, the data transmission device 70 further includes a second sending module 64 and a second receiving module 65.

The second sending module 64 is configured to send a secret key to the client, after receiving by the first receiving module 63 the first data message.

The second receiving module 65 is configured to receive subsequent data messages from the client, in which the subsequent data messages carry data encrypted using the secret key.

In one embodiment, by transmitting the data in the transmission layer using the preset UDP, the data transmission speed in the mobile network scene may be improved and the data transmission delay in the mobile network scene may be reduced, as compared with transmitting data in the transmission layer by using the TCP, thus enhancing a user experience. In another aspect, the application layer may still transmit data using the TCP interface, thus reducing an effect on the application layer.

It should be noted that, terms such as “first” and “second” are used herein for purposes of description and are not intended to indicate or imply relative importance or significance or to imply the number of indicated technical features. In the description of the present disclosure, “a plurality of” means two or more than two, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which should be understood by those skilled in the art.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may include but are not limited to read-only memories, magnetic disks, CD, etc.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A data transmission method, comprising:
receiving data sent by an application layer via a Transmission Control Protocol TCP interface;
performing a protocol conversion when an acceleration mode is started, wherein the protocol conversion refers to converting TCP to a preset User Datagram Protocol UDP; and
sending the data in a transmission layer by using the preset UDP.

2. The data transmission method according to claim 1, wherein performing a protocol conversion comprises:
calling a preset Application Programming Interface API at a client side, and performing the protocol conversion by using the preset API; or
performing the protocol conversion at a server side by using a protocol endpoint.

3. The data transmission method according to claim 1, wherein the preset UDP is a UDP based reliable transmission protocol.

4. The data transmission method according to claim 1, wherein sending the data in a transmission layer by using the preset UDP comprises:
obtaining a current network transmission condition;
computing a transmission time required by each data message according to the network transmission condition;
determining a sending time of each data message according to the transmission time; and
sending the data message at the sending time.

5. The data transmission method according to claim 1, wherein, if the data is sent from a client to a server, sending the data in the transmission layer by using the preset UDP comprises:
sending by the client a first data message to the server, in which the first data message carries data.

6. The data transmission method according to claim 5, further comprising:
receiving by the client a secret key sent by the server, wherein the secret key is sent by the server after receiving the first data message; and
sending by the client subsequent data messages to the server, wherein the subsequent data messages carry data encrypted using the secret key.

7. A data transmission method, comprising:
receiving data sent by a sending end, wherein the data is sent in a transmission layer by using a preset UDP;
performing a protocol conversion when an acceleration mode is started, wherein the protocol conversion refers to converting the preset UDP to TCP; and
sending the data to an application layer via a TCP interface by using the TCP.

8. The data transmission method according to claim 7, wherein the preset UDP is a UDP based reliable transmission protocol.

9. The data transmission method according to claim 7, wherein, if the data is sent from a client and received by a server, receiving the data sent from the sending end comprises:
receiving by the server a first data message sent from the client, in which the first data message carries data.

10. The data transmission method according to claim 9, further comprising:
sending by the server a secret key to the client, after receiving by the server the first data message; and
receiving by the server subsequent data messages from the client, in which the subsequent data messages carry data encrypted using the secret key.

11. A data transmission device, comprising:
a processor; and
a memory, configured to store instructions executable by the processor,
wherein, the processor is configured to:
receive data sent by an application layer via a Transmission Control Protocol TCP interface;
perform a protocol conversion when an acceleration mode is started, in which the protocol conversion refers to converting TCP to a preset User Datagram Protocol UDP; and
send the data in a transmission layer by using the preset UDP.

12. The data transmission device according to claim 11, wherein the processor is configured to call a preset Application Programming Interface API at a client side and to perform the protocol conversion by using the preset API, or the processor is configured to perform the protocol conversion at a server side by using a protocol endpoint.

13. The data transmission device according to claim 11, wherein the preset UDP is a UDP based reliable transmission protocol.

14. The data transmission device according to claim 11, wherein the processor is configured to:
obtain a current network transmission condition;
compute a transmission time required by each data message according to the network transmission condition;
determine a sending time of each data message according to the transmission time; and
send the data message at the sending time.

15. The data transmission device according to claim 11, wherein if the data is sent from a client to a server, the processor is configured to send a first data message to the server, in which the first data message carries data.

16. The data transmission device according to claim 15, wherein the processor is further configured to:
receive a secret key sent by the server, in which the secret key is sent by the server after receiving the first data message; and
send subsequent data messages to the server, in which the subsequent data messages carry data encrypted using the secret key.

17. A data transmission device, comprising:
a processor; and
a memory, configured to store instructions executable by the processor,
wherein, the processor is configured to:
receive data sent by a sending end, in which the data is sent in a transmission layer by using a preset UDP;
perform a protocol conversion when an acceleration mode is started, in which the protocol conversion refers to converting the preset UDP to TCP; and
send the data to an application layer via a TCP interface by using the TCP.

18. The data transmission device according to claim 17, wherein the preset UDP is a UDP based reliable transmission protocol.

19. The data transmission device according to claim 17, wherein, if the data is sent from a client and received by a server, the processor is configured to receive a first data message sent from the client, in which the first data message carries data.

20. The data transmission device according to claim 19, wherein the processor is further configured to:
send a secret key to the client, after receiving the first data message; and
receive subsequent data messages from the client, in which the subsequent data messages carry data encrypted using the secret key.
